(19) United States
(12) Patent Application Publication
(10) Pub. No.: US 2024/0384451 A1
(43) Pub. Date: Nov. 21, 2024

(54) CHARGED NONWOVEN MATERIAL

(71) Applicant: North Carolina State University, Raleigh, NC (US)

(72) Inventor: Behnam Pourdeyhimi, Cary, NC (US)

(21) Appl. No.: 18/686,338

(22) PCT Filed: Aug. 24, 2022
(86) PCT No.: PCT/IB2022/057938

§ 371 Date: Feb. 23, 2024

Related U.S. Application Data
(60) Provisional application No. 63/237,389, filed on Aug. 26, 2021.

(51) Int. Cl. D04H 1/4382; B01D 39/16; D04H 1/4291; D04H 1/4334; D04H 1/435; D04H 1/492; D04H 1/56; D04H 3/007; D04H 3/009; D04H 3/011; D04H 3/11; D04H 3/16

(52) U.S. Cl. CPC D04H 1/4383; B01D 39/163; D04H 1/4291; D04H 1/4334; D04H 1/435; D04H 1/43835; D04H 1/492; D04H 1/56; D04H 3/007; D04H 3/009; D04H 3/011; D04H 3/11; D04H 3/16; B01D 2239/0435; B01D 2239/0618; B01D 2239/0627; B01D 2239/10; D10B 2321/021; D10B 2321/022; D10B 2331/02; D10B 2331/041; D10B 2401/16; D10B 2505/04; D10B 2509/026

(57) ABSTRACT

The disclosure relates to nonwoven fabric including a nonwoven material having a first surface and an opposing second surface, wherein the first surface has a first average surface charge and the second surface has a second average surface charge, the first average surface charge being different from the second average surface charge, wherein the nonwoven material includes a first plurality of fibers including a first polymer and a second plurality of fibers including a second polymer different from the first polymer. A method for imparting surface charge to a nonwoven N61824_1570Wabric is also provided.

### FIELD OF THE INVENTION

The present invention relates to a charged nonwoven material suitable for use in filtration or cleaning applications.

### BACKGROUND OF THE INVENTION

Synthetic fibers are widely used in a number of diverse applications to provide stronger, thinner, and lighter weight products. Synthetic thermoplastic fibers are typically thermos-formable and thus are particularly attractive for the manufacture of nonwoven fabrics, either alone or in combination with other non-thermoplastic fibers (such as cotton, wool, and wood pulp, for example). Nonwoven fabrics, in turn, are widely used as components of a variety of articles, including without limitation absorbent personal care products, such as diapers, incontinence pads, feminine hygiene products, and the like; medical products, such as surgical drapes, sterile wraps, and the like; filtration devices; interlinings; wipes; furniture and bedding construction; apparel; insulation; and packaging materials.

Electrostatic properties of a nonwoven material can enhance filtration efficiency or dust collection. In some cases, electrostatic properties are induced by frictional contact between dissimilar materials, which is sometimes referred to as tribocharging or triboelectric charging. For example, such charging can occur during use of a nonwoven fabric, such as during use of a SWIFFER® brand dusting product, which develops surface charge during frictional contact with a surface to be cleaned. Other nonwoven materials can be tribocharged during manufacture to induce an electrostatic charge within the fibrous material. For example, it is known to card blends of certain dissimilar fibers in order to mechanically induce frictional contact that leads to surface charging. See, for example, U.S. Pat. Nos. 4,798,850 to Brown; 5,368,734 to Wnenchak; 5,470,485 to Morweiser et al.; 5,792,242 to Haskett; 6,328,788 to Auger; 6,547,860 to Buchwald et al.; and 6,808,548 to Wilkins et al. Still further, corona charging can be used to impart surface charge, as set forth in U.S. Pat. No. 4,588,537 to Klasse et al. See, also, the charged fibers set forth in U.S. Pat. Nos. 4,215,682 to Kubik et al.; 5,401,446 to Tsai et al.; 6,119,691 to Angadjivand et al.; and 6,397,458 to Jones et al.

There is a continuing need for improved types of charged nonwoven materials, particularly materials that retain significant charge after aging.

### SUMMARY OF THE INVENTION

The disclosure provides a nonwoven material that includes a nonwoven material having a first surface and an opposing second surface, wherein the first surface and the second surface have different average surface charges. The nonwoven material comprises fibers with two dissimilar polymerics that can induce electrostatic surface charge upon frictional contact therebetween. Surprisingly, it has been discovered that imparting sufficient energy to such a nonwoven material during mechanical entangling can lead to a durable surface charge in the resulting nonwoven.

The disclosure includes, without limitation, the following embodiments.
Embodiment 1: A nonwoven fabric comprising a nonwoven material having a first surface and an opposing second surface, wherein the first surface has a first average surface charge and the second surface has a second average surface charge, the first average surface charge being different from the second average surface charge, wherein the nonwoven material comprises a first plurality of fibers comprising a first polymer and a second plurality of fibers comprising a second polymer different from the first polymer.
Embodiment 2: The nonwoven fabric of Embodiment 1, wherein the first average surface charge is positive and the second average surface charge is negative.
Embodiment 3: The nonwoven fabric of Embodiment 1 or 2, wherein the absolute potential difference in volts between the first average surface charge and the second average surface charge is about 40 V or higher.
Embodiment 4: The nonwoven fabric of any one of Embodiments 1-3, wherein the absolute potential difference in volts between the first average surface charge and the second average surface charge is about 60 V or higher.
Embodiment 5: The nonwoven fabric of any one of Embodiments 1-4, wherein the absolute potential difference in volts between the first average surface charge and the second average surface charge is about 80 V or higher.
Embodiment 6: The nonwoven fabric of any one of Embodiments 1-5, wherein the first polymer is an aliphatic polyester and the second polymer is an aromatic polyester or a polyolefin, or the first polymer is a polyolefin and the second polymer is a polyamide.
Embodiment 7: The nonwoven fabric of any one of Embodiments 1-6, wherein the first polymer is polylactic acid and the second polymer is polytrimethylene terephthalate or polypropylene.
Embodiment 8: The nonwoven fabric of any one of Embodiments 1-7, comprising at least partially fibrillated bicomponent filaments formed from bicomponent fibers having an external fiber component comprising the first polymer and an internal fiber component comprising the second polymer, wherein the external fiber component at least partially enwraps the internal fiber component; and wherein the external fiber component is 5% to 25 wt. % of the bicomponent filament.
Embodiment 9: The nonwoven fabric of any one of Embodiments 1-8, wherein the bicomponent fibers are selected from:
   a. islands-in-the-sea fibers having, e.g., about 20 to about 100 islands;
   b. segmented pie fibers having e.g., about 2 to about 64 segments;
   c. tipped multilobal fibers having e.g., about 3 to about 24 tips;
   d. side-by-side fibers; and
   e. sheath-core fibers.

Embodiment 10: The nonwoven fabric of any one of Embodiments 1-9, wherein the absolute potential difference in volts between the first average surface charge and the second average surface charge is about 40 V or higher after aging at 75° C. and 20% RH following ASTM F1980-07 (reapproved 2011).
Embodiment 11: The nonwoven fabric of any one of Embodiments 1-10, wherein the first plurality of fibers and the second plurality of fibers are continuous filament fibers.
Embodiment 12: The nonwoven fabric of any one of Embodiments 1-11, wherein the first plurality of fibers and the second plurality of fibers are discontinuous fibers having a length ranging e.g., from 3 mm to 150 mm.
Embodiment 13: An air filter or dry wipe comprising the nonwoven fabric of any one of Embodiments 1-12.
Embodiment 14: A method for imparting surface charge to a nonwoven fabric, comprising;
   extruding continuous filament fibers through a spinneret, at least some of the continuous filament fibers comprising a first polymer and at least some of the continuous filament fibers comprising a second polymer different from the first polymer;
   collecting the extruded continuous filament fibers on a collection surface;
   mechanically entangling the collected continuous filament fibers to produce a nonwoven fabric having a first surface and an opposing second surface, wherein the first surface has a first average surface charge and the second surface has a second average surface charge, the first average surface charge being different from the second average surface charge.
Embodiment 15: The method of Embodiment 14, wherein mechanically entangling the continuous filament fibers comprises hydroentangling the continuous filament fibers.
Embodiment 16: The method of Embodiment 14 or Embodiment 15, wherein the hydroentangling comprises hydroentangling with at least three manifolds in series.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable, unless the context of the disclosure clearly dictates otherwise.

It will therefore be appreciated that this brief summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### DESCRIPTION OF THE DRAWINGS

Having thus described the present disclosure in general terms, reference will now be made to the accompanying drawings, which are not necessarily drawn to scale, and wherein:

FIG. 1 shows an islands-in the sea bicomponent fiber;

FIG. 2 depicts a typical bicomponent spunbonding process;

FIG. 3 shows a typical process for hydroentangling;

FIG. 4 illustrates a surface charge testing device utilized in the Experimental section of the present disclosure; and

FIG. 5 illustrates the surface charge testing array of measurements of each sample performed in in the Experimental section of the present disclosure.

### DETAILED DESCRIPTION

The present invention now will be described more fully hereinafter. This invention may, however, be embodied in many different forms and should not be construed as limited to the embodiments set forth herein; rather, these embodiments are provided so that this disclosure will be thorough and complete, and will fully convey the scope of the invention to those skilled in the art. As used in this specification and the claims, the singular forms “a,” “an,” and “the” include plural referents unless the context clearly dictates otherwise. Directional terms, such as “forward,” “rearward,” “front,” “back,” “right,” “left,” “upwardly,” “downwardly,” and the like are words of convenience and are not to be construed as limiting terms.

As used herein, the term “fiber” is defined as a basic element of nonwovens which has a high aspect ratio of, for example, at least about 100 times. In addition, “filaments/continuous filaments” are continuous fibers of extremely long lengths that possess a very high aspect ratio. “Staple fibers” are cut lengths from continuous filaments. Therefore, as used herein, the term “fiber” is intended to include fibers, filaments, continuous filaments, staple fibers, and the like. The term “multicomponent fibers” refers to fibers that comprise two or more components that are different by physical or chemical nature, including bicomponent fibers.

The term “nonwoven” as used herein in reference to fibrous materials, webs, mats, batts, or sheets refers to fibrous structures in which fibers are aligned in an undefined or random orientation. The nonwoven fibers are initially presented as unbound fibers or filaments, which may be natural or man-made. An important step in the manufacturing of nonwovens involves binding the various fibers or filaments together. The manner in which the fibers or filaments are bound can vary, and include thermal, mechanical and chemical techniques that are selected in part based on the desired characteristics of the final product. Nonwoven fabrics or webs have been formed from many processes, which include carding, meltblowing, spunbonding, and air or wet laying processes.

As used herein, the terms “hydroentangle” or “hydroentangling” refers to a process by which a high velocity water jet or even an air jet is forced through a web of fibers causing them to become randomly entangled. Hydroentanglement can also be used to impart images, patterns, or other surface effects to a nonwoven fabric by, for example, hydroentangling the fibers on a three-dimensional image transfer device such as that disclosed in U.S. Pat. No. 5,098,764 to Bassett et al. or a foraminous member such as that disclosed in U.S. Pat. No. 5,895,623 to Trokhan et al., both fully incorporated herein by reference for their teachings of hydroentanglement.

### Nonwoven Fabric

The nonwoven fabrics of the present disclosure produce charged surfaces during manufacturing. The surface charge is the result of frictional contact between two dissimilar polymer fiber materials during entanglement of the nonwoven web. It has been surprisingly discovered that a spunbond nonwoven process applied to fibers of two dissimilar polymers can lead to durable surface charge in the resulting nonwoven fabric.

The nonwoven fabrics comprises two or more dissimilar polymer materials, either as separate monocomponent polymeric fibers made from different polymers, or as multicomponent fiber configurations containing two or more dissimilar polymers. It is advantageous to select polymers with dissimilar effective charge density (c), which can be calculated in units of nC/cm² as set forth in, for example, Liu et al., Triboelectric charge density of porous and deformable fabrics made from polymer fibers, Nano Energy, Volume 53, 2018, Pages 383-390, and particularly advantageous to pair a polymer having a positive effective charge density with a polymer having a negative effective charge density. For example, as can be seen from the cited reference, fabrics made from aliphatic polyesters such as polylactic acid (PLA) or nylon (polyamide) have a relatively high positive effective charge density (e.g., in the range of about 0.3 to about 0.9 nC/cm²), while fabrics made from polyolefins, such as polyethylene (PE) or polypropylene (PP), or aromatic polyesters, such as polyethylene terephthalate (PET), have a negative effective charge density (e.g., in the range of about −0.1 to about −1.3 nC/cm²).

Thus, in certain embodiments, the nonwoven fabric of the present disclosure comprises at least one polymer having a positive effective charge density and at least one polymer having a negative effective charge density, each of the polymers typically selected from among thermoplastic polymers selected from the group consisting of polyesters, polyamides, thermoplastic copolyetherester elastomers, polyolefins, polyacrylates, and thermoplastic liquid crystalline polymers. The two polymers can be combined as monocomponent fibers in the nonwoven fabric, or can be part of multicomponent fiber structures. Example polymer pairings include an aliphatic polyester with a polyolefin, a nylon with a polyolefin, an aliphatic polyester with an aromatic polyester, or a nylon with an aliphatic polyester.

Example aliphatic polyesters include polyglycolic acid (PGA), polylactic acid (PLA), polycaprolactone (PCL), polyethylene adipate (PEA), polybutylene succinate (PBS), polyhydroxyalkonoates (PHA), and copolymers or combinations thereof. Example polyhydroxyalkonoates (PHA) include polyhydroxybutyrate (PHB), poly (3-hydroxybutyrate-co-3-hydroxyvalerate) (PHBV), and copolymers or combinations thereof. Example aromatic polyesters include polyethylene terephthalate (PET), polytrimethylene terephthalate (PTT), polybutlyene terephthalate (PBT), and copolymers or combinations thereof. Example nylons include nylon 6, nylon 6/6, nylon 6,6/6, nylon 6/10, nylon 6/11, nylon 6/12, nylon 11, nylon 12, and copolymers or combinations thereof.

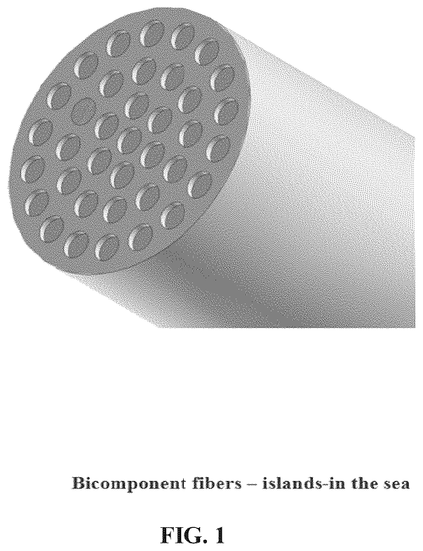

In certain embodiments, the two dissimilar polymer components will be part of an islands-in-the-sea structure. Example bicomponent fibers include those comprising an aliphatic polyester such as polylactic acid (PLA) as the sea component and a polyolefin as the island component, an aromatic polyester such as polytrimethylene terephthalate (PTT) as the island component and an aliphatic polyester as the sea component, or a nylon (polyamide) as the island component and a polyolefin as the sea component. FIG. 1 shows a typical islands-in-the-sea bicomponent filament. The “islands” internal fiber components are enwrapped in the “sea” external fiber component.

The fibers utilized to form the nonwoven fabrics of the present disclosure can vary, and include fibers having any type of cross-section, including, but not limited to, circular, rectangular, square, oval, triangular, and multilobal. In certain embodiments, the fibers can have one or more void spaces, wherein the void spaces can have, for example, circular, rectangular, square, oval, triangular, or multilobal cross-sections. The fibers may be selected from single-component or monocomponent (i.e., uniform in composition throughout the fiber) or multicomponent fiber types (e.g., bicomponent) including, but not limited to, fibers having a sheath/core structure and fibers having an islands-in-the-sea structure, as well as fibers having a side-by-side, segmented pie, segmented cross, segmented ribbon, or tipped multilobal cross-sections. In certain embodiments, the fabrics of the invention will include both monocomponent and multicomponent fibers, and will also typically include more than one type of polymer, either different grades of the same polymer or different polymer types. Nonwoven fabrics and methods for nonwoven production that can be adapted for use in the present disclosure are described in U.S. application Ser. No. 16/855,723 filed on Apr. 22, 2020, as well as in US Pat. Nos. 7,981,226 to Pourdeyhimi et al.; 7,883,772 to Pourdeyhimi et al.; 7,981,336 to Pourdeyhimi, and 8,349,232 to Pourdeyhimi et al., all of which are incorporated by reference herein.

In embodiments with multicomponent fibers, the multicomponent (e.g., bicomponent) fibers will be partially or fully fibrillated. Such structures provide strong filtration efficiency performance at relatively low pressure drop levels. As used herein, “fibrillation” or “fibrillate” refer to at least partially breaking down a nonwoven web comprising the bicomponent fibers into fibrils through application of mechanical energy, resulting in at least partial separation and intertwining of the internal and external components of the bicomponent fibers. Confirmation of at least partial fibrillation of a nonwoven web of bicomponent fibers can be accomplished by visual inspection of Scanning Electron Microscopy (SEM) micrographs. Although not bound by a particular theory of operation, it is also believed that the fibrillation can impart a certain level of electrostatic charge to the nonwoven structure in certain embodiments, which may enhance filtration efficiency. In addition, advantageous embodiments of the spunbond nonwoven material can be reused and re-sterilized by ozone, peroxide, and the like.

Prior to fibrillation, the bicomponent filaments typically include an external fiber component and an internal fiber component, wherein the external fiber component enwraps the internal fiber component. In some embodiments, the external fiber component only partially enwraps the internal fiber component, leaving at least part of the internal fiber component exposed. For example, the bicomponent fiber can be an islands-in-the-sea bicomponent filament having multiple internal fiber components and an external fiber component.

In certain embodiments, the bicomponent filament comprises an island-in-the-sea fiber having from 2 to about 1000 islands (internal components). In certain embodiments, the bicomponent filament has from about 5 to about 400 islands, such as from about 10 to about 200 islands or about 20 to about 100 islands or about 30 to about 40 islands.

During fibrillation, the external fiber component, or sea, is fractured. Thus, the sea component can remain in the finished nonwoven fabric instead of being removed by dissolving or other methods. Leaving the sea component in the finished nonwoven fabric has multiple advantages, including reducing the cost of production and being more environmentally sound because solvents are not needed to dissolve the sea.

In the bicomponent filament, the external fiber component typically comprises from about 5%-30% by weight of the total fiber for ease of fibrillation. In some embodiments, the external component is less than about 20% by weight of the total fiber. In one embodiment, the external component is about 10% or about 15% by weight of the total fiber. In other embodiments, the external fiber component is about 5%-10%, 6%-10%, 7%-10%, 8%-10%, 9%-10%, 5%-15%, 6%-15%, 7%-15%, 8%-15%, 9%-15%, 10%-15%, 11%-15%, 12%-15%, 13%-15%, 14%-15%, 15%, 5%-25%, 10%-25%, 15%-25%, or 15%-30% by weight of the total fiber.

In certain embodiments, the external sea component does not entirely enwrap the internal islands components. In certain embodiments, for example when the sea component is less than 20% by weight of the total fiber, the sea forms a thin barrier between the islands due to the low amount of external sea component. This increases the ease of fibrillation. In certain embodiments, the sea enwraps the islands less than 90%. In certain embodiments, the sea enwraps the islands less than 75%, less than 70%, less than 65%, less than 60%, less than 55%, less than 50%, from 1% to 90%, 10% to 90%, 20% to 90%, 30% to 90%, 40% to 90%, 50% to 90%, 60% to 90%, 70% to 90%, or 80% to 90%.

The spunbond material can contain other components, such as monocomponent fibers intermixed with the bicomponent fibers as set forth, for example, in U.S. Pat. No. 7,981,336 to Pourdeyhimi, which is incorporated by reference herein.

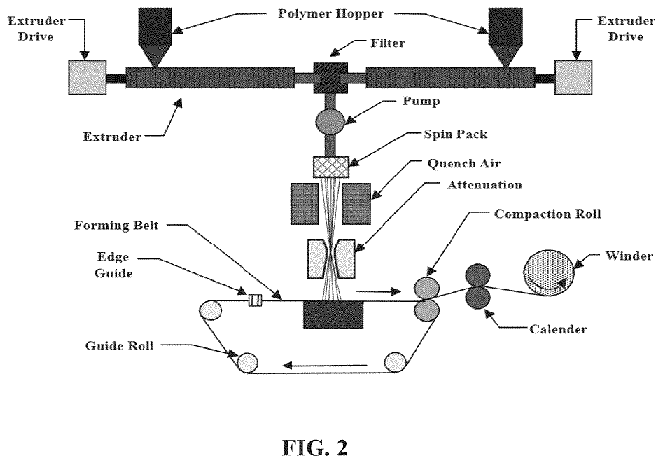

The bicomponent fibers, which typically have a filament size of between about 10 to about 100 microns (e.g., about 15 to about 20 microns) are formed into a nonwoven using a nonwoven forming process such as a spunbonding process. FIG. 2 shows an example of a typical bicomponent filament spunbonding process. Polymer is fed from a hopper into an extruder. The polymer is heated in the extruder, melting the polymer. The polymer can be mixed with additives in the extruder. The molten polymer passes through a filter and into a pump. The polymer then moves into the spin pack which contains a spinneret. The spinneret has holes that form the molten polymer into fibers or filaments. Quench air cools the polymer, causing the polymer to solidify. In attenuation, the polymer filaments are stretched, orienting the molecules in the polymer.

In the exemplary process shown in FIG. 2, the polymer filaments are deposited on a forming belt to form a web. The web then passes through a compaction roll and a calender, which bonds the filaments together to form a fabric. Bonding methods used in spunbonding processes can include hydroentangling, needlepunching, thermal bonding, and other methods.

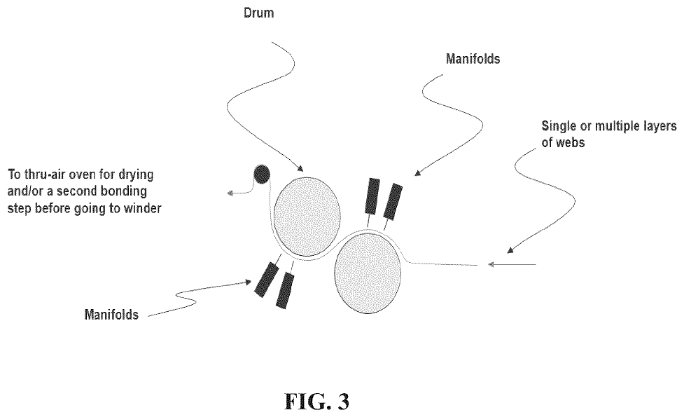

For purposes of the present disclosure, it is advantageous for the bonding process to include hydroentangling, which also causes fibrillation of any bicomponent fibers within the nonwoven web. FIG. 3 shows a typical process for hydroentangling. FIG. 3 shows a drum entangler using two drums and four injectors. A pre-wet injector/manifold may be used as well, and there may be more drums and injectors used. In some embodiments, the surface of the drum used in hydroentangling is smooth to enhance separation of the fibrils after fibrillation.

Typically, the fibrillation process utilizes hydro energy for fibrillating the external fiber component. The hydro energy used for fibrillation is also sufficient for hydroentangling the set of bicomponent filaments/fibers. The hydroentanglement process typically occurs after the bicomponent filaments/fibers have been positioned onto a belt carrier in the form of a web.

The web or the nonwoven fabric can be exposed to one or more hydroentangling manifolds to fibrillate and hydroentangle the fiber components. The web or nonwoven fabric can have a first surface and a second surface. In certain embodiments, the first surface is exposed to water pressure from one or more hydroentangling manifolds. In other embodiments, the first surface and second surface are exposed to water pressure from one or more hydroentangling manifolds. The one or more hydroentangling manifolds can have a water pressure from 10 bars to 1000 bars. Example water pressure used for hydroentanglement can be from 10 bars and 500 bars. In certain embodiments, the water pressure used for hydroentanglement is from 10 bars to 100 bars, 10 bars to 200 bars, 10 bars to 300 bars, 10 bars to 400 bars, 10 bars to 600 bars, 100 bars to 200 bars, 300 bars to 400 bars, 500 bars to 600 bars, 600 bars to 700 bars, 700 bars to 800 bars, 800 bars to 900 bars, 900 bars to 1000 bars, or 500 bars to 1000 bars. In certain embodiments, the water pressure used for hydroentanglement is from 10 bars to 300 bars. In additional embodiments, a series of injectors or manifolds are used, and the pressure is gradually increased.

In certain embodiments, the hydroentangling manifold water jets are spaced at least 1200 microns away from each other. In some other examples, the water jets are spaced from 1200 microns to 4800 microns apart, e.g., from 1200 microns to 1800 microns, 1200 microns to 2400 microns, 1800 microns to 2400 microns, 1800 microns to 2400 microns, or 2400 microns to 4800 microns apart. Each water jet spacing pertains to one manifold. In certain embodiments, for the disclosed method, 3, 4, 5, or 6 manifolds can be used. In other embodiments, more than 6 manifolds can be used.

In some embodiments, hydroentangling can use multiple manifolds where the spacing of the water jets increases or decreases from the first manifold or set of manifolds to the last manifold or set of manifolds. For example, at least 3 manifolds can have jet spacings of at least 1200 microns, where the rest are below 1200 microns. In other embodiments, at least 4, 5, or 6 manifolds can have jets at least 1200 microns apart where the rest are below 1200 microns. In some other embodiments, at least 3, 4, or 5 manifolds can have jet spaced at least 2400 microns apart where the rest are less than 2400 microns apart. In additional embodiments, 6 manifolds can be used with at least three of the water jets being spaced 1200 microns apart, at least two of the water jets being spaced at least 2400 microns apart, and at least one of the water jets being spaced 600 microns apart. In other embodiments, 5 manifolds can be used with at least two of the water jets being spaced 1200 um apart, at least two of the water jets being spaced at least 2400 um apart, and at least one of the water jets being spaced 600 microns apart. In yet other embodiments, 4 manifolds can be used with at least two of the water jets being spaced 1200 um apart and at least two of the water jets being spaced at least 2400 microns apart. In further embodiments, 3 manifolds can be used with at least two of the water jets being spaced 1200 microns apart. This spacing of the manifold jet strips can lead to partial fibrillation of the bicomponent filaments/fibers. The partial fibrillation allows for a low-density material with a low pressure drop while keeping a high efficiency. The structure of the material is made up of fine fibrils and larger fibers. Partial fibrillation can result, for example, in about 50% of the fibers being fibrillated. This can be determined by SEM micrographs. In some examples, from 80% to 10% of the fibers are fibrillated, e.g., 70%, 60%, 50%, 40%, 30%, 20%, or 10%, where any value can form the upper or lower endpoint of a range, can be fibrillated as determined by SEM micrographs.

It is believed that nonwoven fabrics with particularly advantageous surface charging can be made from bicomponent fibers fibrillated with a certain minimum amount of energy. The energy imparted to the fibers during hydroentanglement or other bonding processes not only entangles the fibers into a cohesive web, but also causes sufficient friction between the dissimilar polymer materials to cause significant surface charging. It is advantageous for the hydroentangling pressure introduced during hydroentanglement or other bonding processes to exceed about 50 bar, such as about 100 bar to about 250 bar. This level of energy typically requires multiple manifolds, such as hydroentanglement systems with greater than 2, greater than 3, greater than 4, greater than 5, or greater than 6 manifolds (e.g., 4 to 10 manifolds or 4 to 9 manifolds or 5 to 8 manifolds).

The above process produces micro-denier fibers which can be from 0.1 and 5 microns in diameter. In certain embodiments, the diameter is from 0.1 and 0.5 microns, 0.5 and 1 microns, 1 and 1.5 microns, 1.5 and 2 microns, 2 and 2.5 microns, 2.5 and 3 microns, 3 and 3.5 microns, 3.5 and 4 microns, 4 and 4.5 microns, 4.5 and 5 microns, 0.1 and 1 microns, 0.1 and 2 microns, 0.1 and 3 microns, 0.1 and 4 microns, 1 and 5 microns, 2 and 5 microns 3 and 5 microns, or 4 and 5 microns.

By at least partially fibrillating the external fiber component, a spunbond nonwoven fabric comprising microfibers or nanofibers can be produced which can be used for construction of masks or other filtration media, as well as the construction of cleaning wipes, particularly dry wipes. In certain embodiments, the thickness of the spunbond fabric that results from this disclosed method can be from 1 to 2 mm, e.g., from 1 mm to 1.2 mm, from 1 mm to 1.4 mm, from 1.4 mm to 1. 6 mm, from 1.4 mm to 1.8 mm, or 1.4 mm to 2 mm.

In some embodiments, the basis weight of the spunbond nonwoven web is about 200 g/m² or less, about 175 g/m² or less, about 150 g/m² or less, about 125 g/m² or less, about 100 g/m² or less, or about 75 g/m² or less. In certain embodiments, the spunbond nonwoven fabric has a basis weight of about 75 g/m² to about 200 g/m², such as about 100 to about 150 g/m². In certain embodiments, multiple spunbond layers are used in the nonwoven structure, with a total spunbond layer basis weight of about 225 g/m² or greater, about 250 g/m² or greater, about 275 g/m² or greater, or about 300 g/m² or greater. The basis weight of the fabric can be measured, for example, using test methods outlined in ASTM D 3776/D 3776M-09ae2 entitled “Standard Test Method for Mass Per Unit Area (Weight) of Fabric.” This test reports a measure of mass per unit area and is measured and expressed as grams per square meter (i.e., gsm or g/m²).

Certain embodiments of the nonwoven fabric have a filtration efficiency of about 80% or higher, or about 85% or higher or about 90% or higher or about 95% or higher or about 98% or higher or about 99% or higher (e.g., about 90% to about 99% or about 95% to about 99%), measuring at a flow rate of 60 L/min and a sample area of 100 cm2 according to NIOSH Procedure No. TEB-APR-STP-0059. Example ranges of pressure drop for certain example embodiments of the nonwoven fabric include about 50 Pa or less or about 45 Pa or less or about 40 Pa or less or about 35 Pa or less, such as a range of about 10 to about 50 Pa or about 20 to about 40 Pa, measured at a flow rate of 60 L/min and a sample area of 100 cm2. Such pressure drop can be measured as the initial pressure recorded during the loading test (NIOSH Procedure No. TEB- APR-STP-0059).

### Fiber Additives

The nonwoven fabrics of the present disclosure, or portions or layers thereof, are electrostatically charged. Due to conductivity within the material and ionic attacks from the environment, it is possible that this charge will decay after a period of time, which can lead to reduction of filtration efficiency. Accordingly, in certain embodiments, one or more charge stabilizer additives adapted to increase filtration efficiency and enhance longevity of the surface charge of the fabric can be added to one or of the polymers that form the nonwoven material. Example additives include metal salts of fatty acids such as stearic acid (e.g., magnesium, zinc, or aluminum stearate), titanate salts such as alkaline earth metal titanate salts (e.g., barium titanate or perovskite), silicate salts such as tourmaline, and other mineral materials such as perlite. When present, the amount of this type of additive is typically in the range of less than about 10% by weight of the overall fiber composition, such as less than about 7.5% or less than about 5% (e.g., about 0.1 to about 10% by weight or about 0.1 to about 5% by weight).

The polymer composition used to form any of the nonwoven materials noted herein can optionally include other components not adversely affecting the desired properties thereof. Examples include, without limitation, antioxidants, particulates, pigments, and the like. These and other additives can be used in conventional amounts.

### Optional Electrostatic Charging

The nonwoven web, or a portion or layer thereof. can be treated to induce additional electrostatic charge within the fibrous material, which enhances filtration efficiency and dust collection of the material. Electric charge can be imparted to the fibers by various methods including, but not limited to, corona charging, tribocharging, hydrocharging, and plasma fluorination. See, for example, the electric charging techniques set forth in U.S. Pat. No. 4,215,682 to Kubik et al.: U.S. Pat. No. 4,588,537 to Klasse et al.: U.S. Pat. No. 4,798,850 to Brown; U.S. Pat. No. 5,401,446 to Tsai et al.: U.S. Pat. No. 6,119,691 to Angadjivand et al.: and U.S. Pat. No. 6,397,458 to Jones et al . . . all of which are incorporated by reference herein. In one particular embodiment. the fibrous material is charged using corona charging by treating one or both sides of the nonwoven web with charging bars, such as those available from Simco-Ion, which can be placed close to the surface of the nonwoven web (e.g., about 20 to about 60 mm) and operating at a voltage of about 35 to about 50 kV.

### EXPERIMENTAL

### Spunbond Preparation

A series of spunbond webs were prepared using bicomponent islands-in-the-sea fibers. Specifically. spunbond webs were formed from the following: (Example 1) bicomponent islands-in-the-sea fibers having 37 PP islands and a PLA sea (90% PP/10% PLA by weight) having a basis weight of 125 gsm and including 1% by weight barium titanate: (Example 2) bicomponent islands-in-the-sca fibers having 37 PP islands and a PLA sea (90% PP/10% PLA by weight) having a basis weight of 125 gsm and including 2% by weight barium titanate: (Example 3) bicomponent islands-in-the-sca fibers having 37 PP islands and a PLA sea (90% PP/10% PLA by weight) having a basis weight of 100 gsm and including no additives: (Example 4) bicomponent islands-in-the-sca fibers having 37 PP islands and a PLA sca (90% PP/10% PLA by weight) having a basis weight of 80 gsm and including no additives: (Example 5) bicomponent islands-in-the-sea fibers having 37 PTT islands and a PLA sca (90% PTT/10% PLA by weight) having a basis weight of 80 gsm and including no additives: (Example 6) bicomponent islands-in-the-sca fibers having 37 PTT islands and a PLA sea (90% PTT/10% PLA by weight) having a basis weight of 125 gsm and including no additives: and (Example 7) bicomponent islands-in-the-sea fibers having 37 nylon islands and a PE sca (90% nylon/10% PE by weight) having a basis weight of 125 gsm and including no additives. The spunbond webs were partially fibrillated with water jets by using a low pressure (30 bar) prewet injector and 8 high pressure injectors (100-250 bar) comprising hydroentangling jet strips with the jets spaced at 1200, 1200, 1200, 1200, 1200, 600, 600 microns apart. with a pre-wet manifold having jets 1200 microns apart.

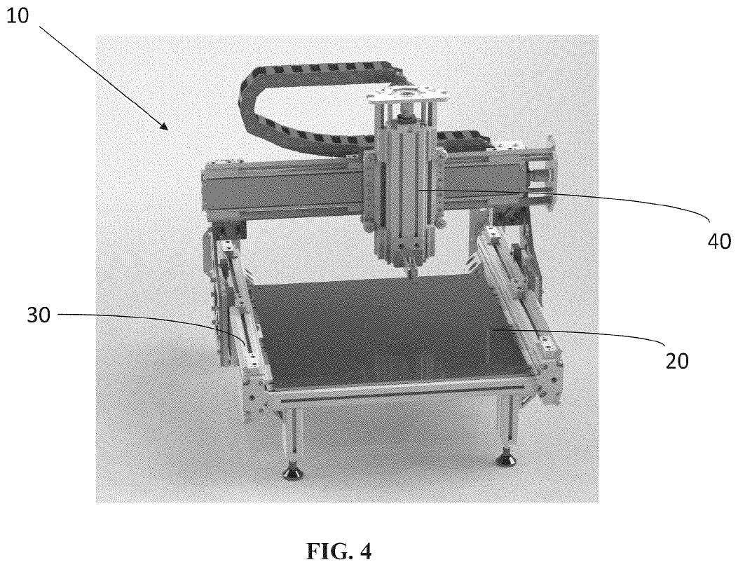

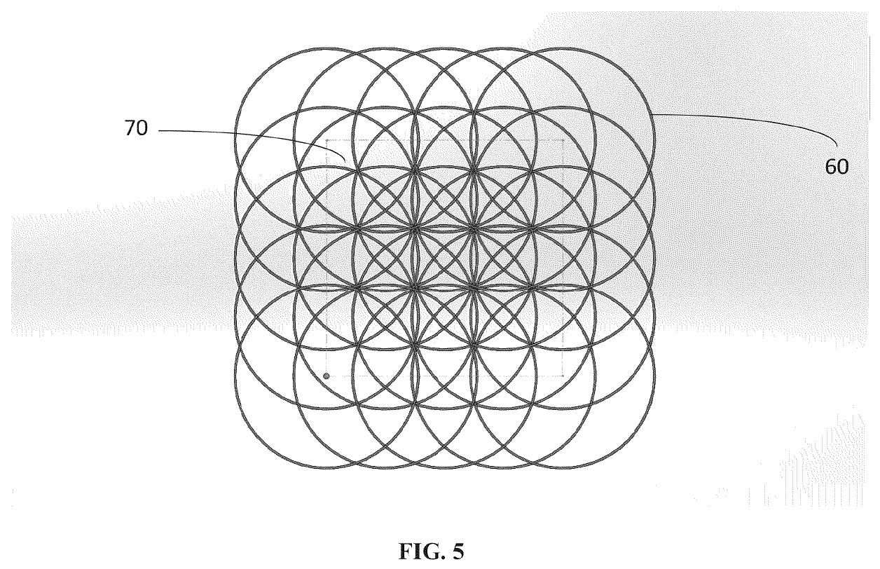

The surface charge for both the front and back of cach sample web was measured using an X-Y table with a KEYENCE SK-1000 in-line static sensor mounted thereon, as shown in FIG. 4. As shown, the surface charge in volts was measured using the testing device 10 by placing an 8×8 inch web sample on a grounded plate 20 on the X-Y table 30 and measuring the voltage with the probe 40 at a measurement distance of 25 mm and by scanning overlapping 80 mm diameter sections of the sample. This results in a 5 by 5 array of measurements as graphically illustrated in FIG. 5, which shows the overlapping 80 mm diameter sections 60 and the sample 70.

The surface charge of both surfaces of each sample were measured using the above process, which creates and array of charge values for each surface. Those surface charge values were averaged for each surface and this data are presented in Table 1 below. The absolute potential difference between the front and back faces of the fabrics was also calculated. The examples noted above were also compared to a commercially available cellulose paper towel, which was expected to have no significant charge, to ensure the testing apparatus was functioning correctly. The resolution of the Keyence device is 10 volts. It is noted that the cellulose paper towel numbers below are within the error of the device.

TABLE 1

| | Front Surface | Back Surface | Absolute Potential |
|---|---|---|---|
| | Average | Average | Difference |
| Test Sample | Charge (V) | Charge (V) | (Front/Back) |
| Cellulose Paper | −4.08 | −4.88 | 0.80 |
| Towel | | | |
| Example 1 | 419.92 | −492.96 | 73.04 |
| Example 2 | 419.16 | −547.96 | 128.8 |
| Example 3 | 414.12 | −292.44 | 121.68 |
| Example 4 | 586.6 | −414.08 | 154.52 |
| Example 5 | −188.76 | −95.24 | 93.52 |
| Example 6 | −220.2 | −7.52 | 212.68 |
| Example 7 | −108.08 | −126.96 | 18.88 |

As expected, the cellulose paper towel exhibited essentially no difference in surface charge between surfaces. The absolute potential difference is more related to particle filtration where the particles are carried by an air stream (as in filtration), and the potential is indicative of the strength of the charge for capturing such particles. Larger differences in measured voltage between the two opposing surfaces and larger absolute potential differences should correlate to stronger performance as charged filtration media or dry wipe media. The surface charge would be indicative of the strength of the attraction for particles when the web comes in contact with the surface as in wipes.

Surface charge is typically not stable and will decline over time, and this charge decay typically accelerates with increasing temperature. Some of the above fabric samples were subjected to simulated aging for six weeks at 75° C. and 20% relative humidity (RH) following ASTM F1980-07 (reapproved 2011), which represents a real time shelf life of 60 months. The surface charge of both surfaces was again tested using the same procedure noted above after aging and the results are shown in Table 2 below.

TABLE 2

| | Front Surface | Back Surface | Absolute Potential |
|---|---|---|---|
| | Average | Average | Difference |
| Test Sample | Charge (V) | Charge (V) | (Front/Back) |
| Example 2 | 388.92 | −572.52 | 183.6 |
| Example 3 | 400.2 | −642.48 | 242.28 |
| Example 4 | 410.2 | −540.68 | 130.48 |

Surprisingly, the surface charge of each tested sample was remarkably stable after aging. Each aged sample still showed significant surface charging after aging. Only Example 2 included an additive intended to retard surface charge decay, yet all three samples showed well-preserved surface charge after aging.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A nonwoven fabric comprising a nonwoven material having a first surface and an opposing second surface, wherein the first surface has a first average surface charge and the second surface has a second average surface charge, the first average surface charge being different from the second average surface charge, wherein the nonwoven material comprises a first plurality of fibers comprising a first polymer and a second plurality of fibers comprising a second polymer different from the first polymer.

2. The nonwoven fabric of claim 1, wherein the first average surface charge is positive and the second average surface charge is negative.

3. The nonwoven fabric of claim 1, wherein the absolute potential difference in volts between the first average surface charge and the second average surface charge is about 40 V or higher.

4. The nonwoven fabric of claim 1, wherein the absolute potential difference in volts between the first average surface charge and the second average surface charge is about 60 V or higher.

5. The nonwoven fabric of claim 1, wherein the absolute potential difference in volts between the first average surface charge and the second average surface charge is about 80 V or higher.

6. The nonwoven fabric of claim 1, wherein the first polymer is an aliphatic polyester and the second polymer is an aromatic polyester or a polyolefin, or the first polymer is a polyolefin and the second polymer is a polyamide.

7. The nonwoven fabric of claim 1, wherein the first polymer is polylactic acid and the second polymer is polytrimethylene terephthalate or polypropylene.

8. The nonwoven fabric of claim 1, comprising at least partially fibrillated bicomponent filaments formed from bicomponent fibers having an external fiber component comprising the first polymer and an internal fiber component comprising the second polymer, wherein the external fiber component at least partially enwraps the internal fiber component; and wherein the external fiber component is 5% to 25 wt. % of the bicomponent filament.

9. The nonwoven fabric of claim 8, wherein the bicomponent fibers are selected from:
a. islands-in-the-sea fibers having about 20 to about 100 islands;
b. segmented pie fibers having about 2 to about 64 segments;
c. tipped multilobal fibers having about 3 to about 24 tips;
d. side-by-side fibers; and
e. sheath-core fibers.

10. The nonwoven fabric of claim 1, wherein the absolute potential difference in volts between the first average surface charge and the second average surface charge is about 40 V or higher after aging at 75° C. and 20% RH following ASTM F1980-07 (reapproved 2011).

11. The nonwoven fabric of claim 1, wherein the first plurality of fibers and the second plurality of fibers are continuous filament fibers.

12. The nonwoven fabric of claim 1, wherein the first plurality of fibers and the second plurality of fibers are discontinuous fibers having a length ranging from 3 mm to 150 mm.

13. An air filter or dry wipe comprising the nonwoven fabric according to claim 1.

14. A method for imparting surface charge to a nonwoven fabric, comprising;
extruding continuous filament fibers through a spinneret, at least some of the continuous filament fibers comprising a first polymer and at least some of the continuous filament fibers comprising a second polymer different from the first polymer;
collecting the extruded continuous filament fibers on a collection surface;
mechanically entangling the collected continuous filament fibers to produce a nonwoven fabric having a first surface and an opposing second surface, wherein the first surface has a first average surface charge and the second surface has a second average surface charge, the first average surface charge being different from the second average surface charge.

15. The method of claim 14, wherein mechanically entangling the continuous filament fibers comprises hydroentangling the continuous filament fibers.

16. The method of claim 15, wherein the hydroentangling comprises hydroentangling with at least three manifolds in series.
